(19) United States
(12) Patent Application Publication
(10) Pub. No.: US 2017/0313129 A1
(43) Pub. Date: Nov. 2, 2017

(54) Quick Replace Axle

(71) Applicant: Seth Garrett, Morton, MS (US)

(72) Inventor: Seth Garrett, Morton, MS (US)

(21) Appl. No.: 15/484,786

(22) Filed: Apr. 11, 2017

Related U.S. Application Data
(60) Provisional application No. 62/329,764, filed on Apr. 29, 2016.

(51) Int. Cl. B60B 35/02; B60B 27/00; B60B 27/02; B60B 35/04; B60T 13/12

(52) U.S. Cl. CPC B60B 35/025; B60B 27/02; B60B 27/0057; B60B 35/04; B60B 27/0052; B60B 27/0063; B60B 2900/541; B60T 13/12

(57) ABSTRACT

A quick replace axle for use on the non-drive axles of a vehicle comprising an outer sleeve and an inner axle wherein the inner axle fits into the outer sleeve and is held in place with a plurality of secure pins. The quick replace axle may also be hydraulic and may include a disk break assembly or a drum break assembly.

This application claims the benefit of U.S. Provisional Application No. 60/232,9764, filed Apr. 29, 2016.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### AMENDED DESCRIPTION

### FIELD OF THE INVENTION

This disclosure relates to a quick replace axle for non-drive axles of a vehicle. Many vehicles have non-drive axles. When these axles break down it is an expensive and time-consuming endeavor to replace the axle. The present disclosure reveals a quick replace axle that involves jacking the vehicle off the ground, removing a plurality of secure pins, pulling the inner axle from the outer sleeve, installing the replacement inner axle that may already have the wheel attached, replacing the plurality of secure pins and lowing the vehicle back to the ground.

### AMENDED BACKGROUND OF THE INVENTION

Many vehicles have non-drive axles. When these axles break down it is an expensive and time-consuming endeavor to replace the axle. In U.S. Pat. No. 5,692,779, Hedgepeth reveals a trailer with easy change axles, whereas the present disclosure reveals a quick replace axle for use with the non-drive axles of any vehicle, wherein the axle sleeve and inner axle may be another shape other than rectangular, secure pins that are not ““L” shaped” and further reveals a hydraulic version of the quick replace axle and the capability of having a disk or drum break assembly included with the quick replace axle.

### SUMMARY OF THE INVENTION

The present disclosure reveals a quick replace axle comprising an outer sleeve, and an inner axle wherein the outer sleeve can be attached by means of bolts or welds to the location of the non-drive axle of a vehicle and the inner axle comprises a length capable of fitting into the outer sleeve with a spindle on a first end of the length of the inner axle which is capable of attaching a wheel assembly. The wheel assembly comprises an inner bearing, inner cup, hub with studs to attach a wheel, an outer cup, outer bearing, washer, nut, and pin. A plurality of holes are aligned to pass through the outer sleeve and the inner axle in order to hold the outer sleeve and inner axle together.

The axle may also act as a hydraulic cylinder for a hydraulic axle wherein each of the plurality of holes in the inner axle further comprise a plurality of sleeves that fit into the plurality of holes and are welded in place. A hydraulic fitting on the end of the length of the inner axle completes the seal on the inner axle and allows the inner axle to be connected to the remaining portion of a hydraulic axle system. In either the hydraulic or non-hydraulic version of the quick replace axle a disk break assembly or drum break assembly may be included.

### BRIEF DESCRIPTION OF THE SEVERAL VIEWS OF THE DRAWING

FIG. 1 is a view of the outer sleeve, inner axle and wheel assembly;

FIG. 2A is a view of the outer sleeve as a single sleeve;

FIG. 2B is a view of the outer sleeve as a pair of sleeves;

FIG. 2C is a view of the outer sleeve as a plurality of sleeves;

FIG. 3A is a view of the outer sleeve and wheel assembly for the hydraulic version of the quick replace axle;

FIG. 3B is a view of the outer sleeve and inner axle for the hydraulic version of the quick replace axle;

FIG. 4 is a view of the inner axle of the quick replace axle with a wheel assembly;

FIG. 5 is a view of the inner axle of the quick replace axle with a disk break assembly;

FIG. 6 is a view of the inner axle of the quick replace axle with a drum break assembly;

FIG. 7 is a view of the wheel assembly;

FIG. 8 is a view of the disk break assembly; and

FIG. 9 is a view of the drum break assembly.

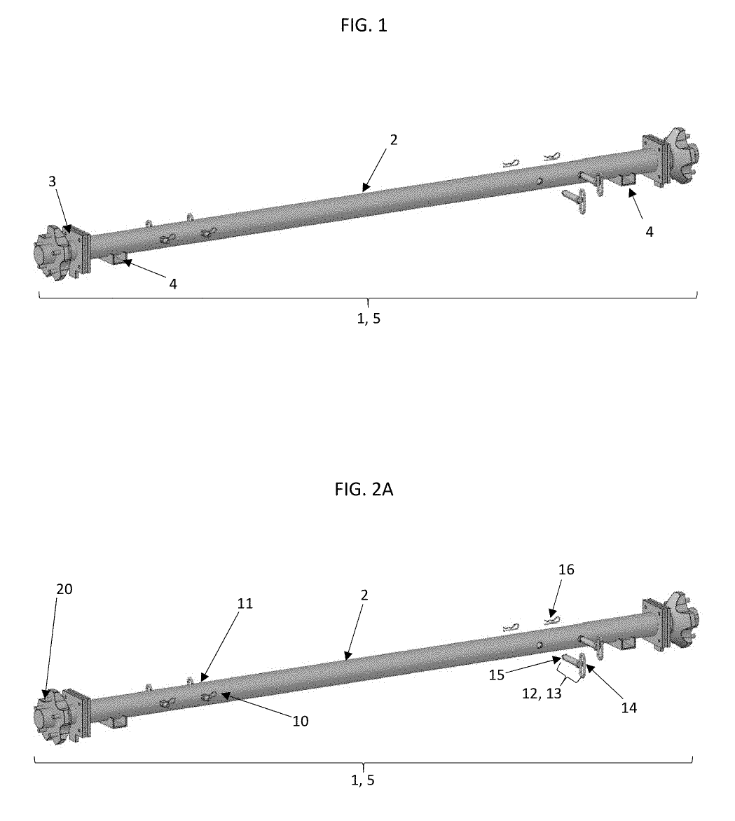

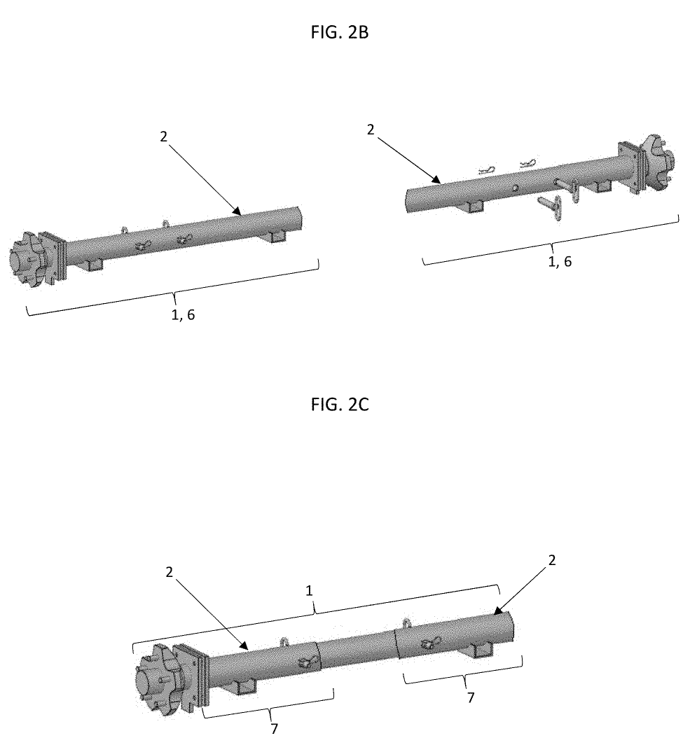

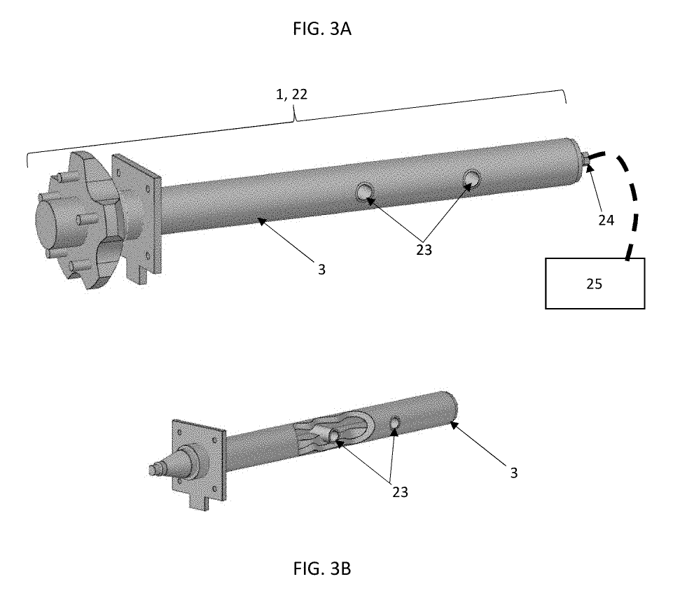

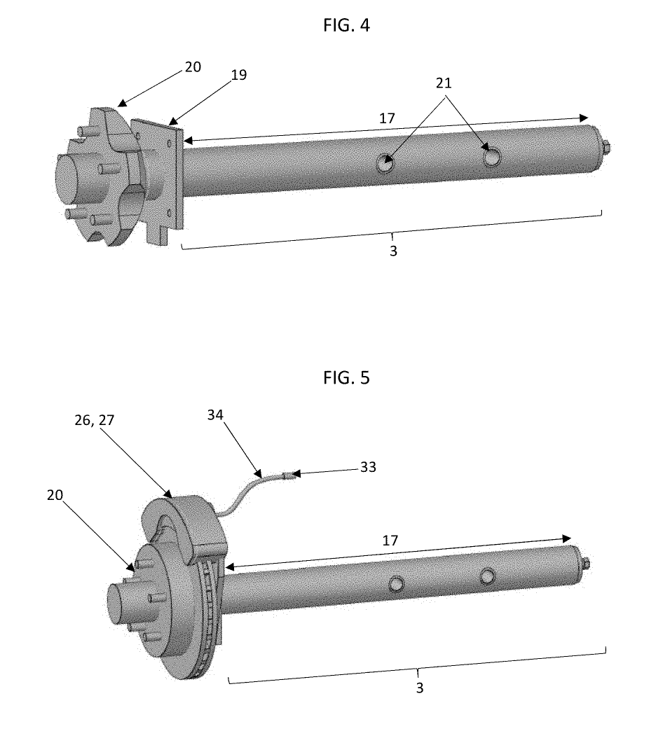

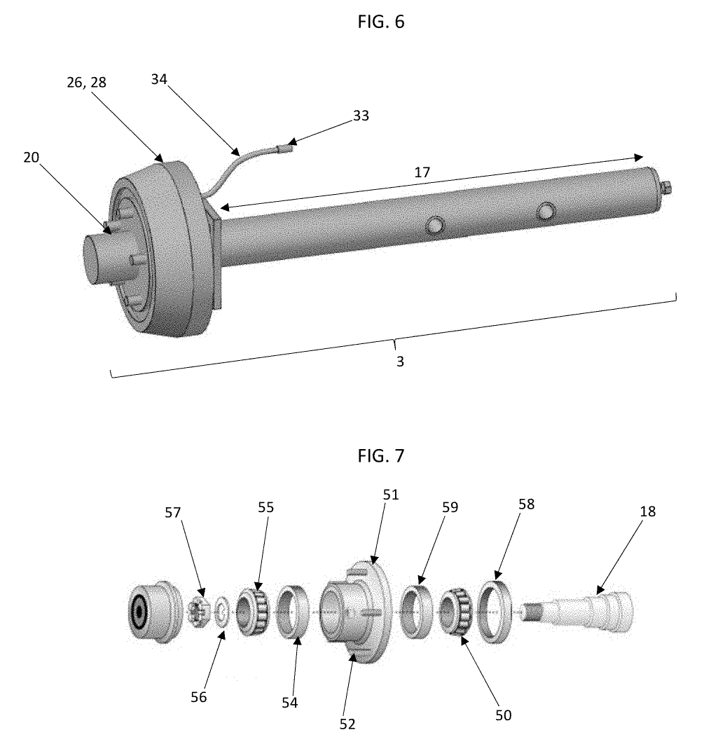

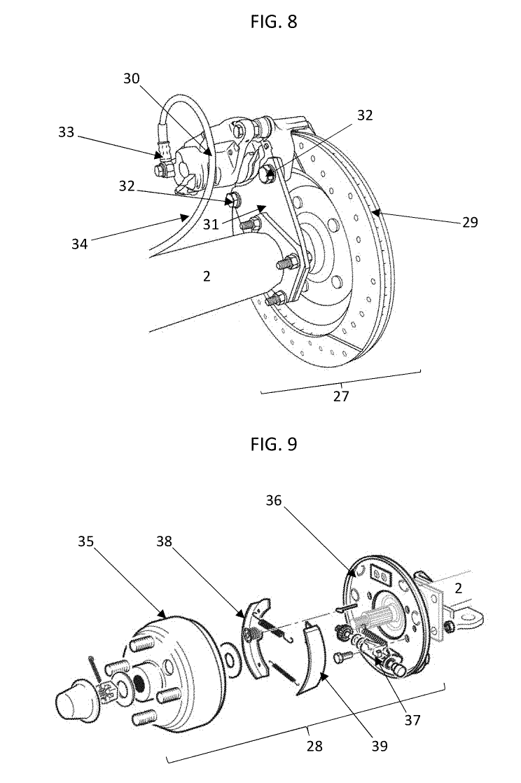

### DETAILED DESCRIPTION OF THE INVENTION

Present disclosure reveals a quick replace axle 1 for the non-drive axles of a vehicle comprising an outer sleeve 2, and an inner axle 3. The outer sleeve 2 is attached to a vehicle in the location where the wheel axle assembly would be located by an attachment means 4 such as a weld or bolts. The outer sleeve 2 can be a single sleeve 5 that extends from one side of the vehicle to the opposing side of the vehicle, could be a pair of sleeves 6, one sleeve 2, 6 for one side of the vehicle with a second sleeve 2, 6 on the opposing side of the vehicle for the opposite wheel, or the outer sleeve 2 could be a plurality of sleeves 7 aligned such that the inner axle 3 on each side of the vehicle can be inserted through the plurality of sleeves 7 in order for the axle to be attached to the vehicle. There are a plurality of holes 8 in the outer sleeve 2 such that a secure pin 9 can pass from a first side 10 of the outer sleeve 2, through outer sleeve 2 and continue to pass through an opposing side 11 of the outer sleeve 2. The secure pin 9 comprises a main shaft 12 with a length 13 and a head region 14, whereby the head region 14 may comprise a bend in the main shaft or a larger head portion. The secure pin 9 further comprises a hole 15 that passes through the main shaft 12 perpendicularly to the length 13 of the main shaft 12 to allow a cotter pin 16 to pass through the hole 15 in the main shaft 12 in order to prevent the secure pin 9 from being removed without the removal of the cotter pin 16.

The inner axle 3 comprises an axle length 17 and a spindle 18 at a first end 19 of the inner axle 3 to which a wheel assembly 20 is attached. The wheel assembly 20 comprises an inner bearing 50, inner cup 59, hub 51 with studs 52 to attach a wheel, an outer cup 54, outer bearing 55, washer 56, nut 57, and seal 58. The axle length 17 comprises a plurality of holes 21 that align with the plurality of holes 8 in the outer sleeve 2 such that the secure pin 9 can pass from the first side 10 of the outer sleeve 2, through the axle length 17, and continue to pass through the opposite side 11 of the outer sleeve 2, so that the inner axle 3 can be attached to the outer sleeve 2.

The inner axle 3 may further be act as a hydraulic axle 22 therein the inner axle 3 further comprises a plurality of sleeves 23 and a hydraulic coupling 24. The plurality of sleeves 23 are co-located with the plurality of holes 21 in the inner axle 3, fit through the plurality of holes 21 and are sealed to the inner axle 3. The hydraulic coupling 24 is located at the end opposite the spindle 18 to connect the inner axle 3 to a hydraulic system 25.

An additional embodiment of the quick replace axle 1 comprises a brake assembly 26 for either disk brakes 27 or drum brakes 28.

For a disk break assembly 27 version of the quick replace axle 1, the disk break assembly 27 comprises a rotor 29 and break pad assembly 30. The rotor 29 is attached to the hub 51 the rotor 29 and the break pad assembly 30 is bolted to a support plate 31, the support plate 31 being attached to the inner axle 3 by an attachment means 32 such as a weld or bolts. The disk break assembly 27 further comprises a hydraulic coupling 33 such that the break pad assembly 30 can be charged with hydraulic fluid without risk of leakage and a brake-line 34 of the vehicle can be removed from the disk break of the quick release axle 1 that is being removed and connected to the disk break assembly 27 on the new quick replace axle 1 with minimal the need of bleeding the brake-line 34.

For a drum break assembly 28 version of the quick replace axle 1, the drum break assembly 28 comprises a break drum 35, backing plate 36, break cylinder 37, a leading line shoe assembly 38, and a trailing line shoe assembly 39. The backing plate 36 is attached to the spindle 18 and comprises the break cylinder 37, leading line shoe assembly 38, and trailing line shoe assembly 39. The break drum 35 is attached to the studs 52 of the wheel assembly 20. The drum break assembly 28 further comprises a hydraulic coupling 33 such that the drum break assembly 28 can be charged with hydraulic fluid without risk of leakage and a brake-line 34 of the vehicle can be removed from the drum break assembly 28 of the quick release axle 1 that is being removed and connected to the drum break assembly 28 on the new quick replace axle 1 with minimal need of bleeding the brake-line 34.

What is claimed:

1. A quick replace axle for the non-drive axles of a vehicle comprising:
an outer sleeve, and an inner axle;
the outer sleeve capable of being attached to a vehicle in the location where a wheel axle assembly would be located by an attachment means such as a weld or bolts;
the outer sleeve further comprising a plurality of holes in the outer sleeve such that a secure pin can pass from a first side of the outer sleeve and continue to pass through an opposite side of the outer sleeve;
wherein the secure pin comprises a main shaft with a length at the end of the and a head region, whereby the head region may comprise a bend in the main shaft or a larger head portion and further comprises a hole that passes through the main shaft perpendicularly to the length of the main shaft to allow a cotter pin to pass through the hole in the main shaft in order to prevent the secure pin from being removed without the removal of the cotter pin;
the inner axle comprises an axle length and a spindle at a first end of the inner axle to which a wheel assembly is attached;
the wheel assembly comprising an inner bearing, inner cup, hub with studs to attach a wheel, an outer cup, outer bearing, washer, nut, and seal. and
the axle length comprises a plurality of holes that align with the plurality of holes in the outer sleeve such that the secure pin can pass from the outside of the outer sleeve, through the inside of the outer sleeve, through the axle length, and continue to pass through the opposing side of the outer sleeve, so that the inner axle can be attached to the outer sleeve.

2. The quick replace axle of claim 1 wherein outer sleeve is made up of a single sleeve that extends from one side of the vehicle to the opposing side of the vehicle.

3. The quick replace axle of claim 2 wherein the inner axle further comprises a disk break assembly;
the disk break assembly comprises a rotor and break pad assembly;
the rotor is attached to the hub a rotor and the break pad assembly is bolted to a support plate;
the support plate being attached to the inner axle by an attachment means; and
the disk break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

4. The quick replace axle of claim 2 wherein the inner axle further comprises a drum break assembly;
the drum break assembly comprises a break drum, backing plate, break cylinder a leading line shoe assembly, and a trailing line shoe assembly;
the backing plate is attached to the spindle and comprises the break cylinder, leading line shoe assembly, and trailing line shoe assembly;
the break drum is attached to the stud of the wheel assembly; and
the drum break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

5. The quick replace axle of claim 2 wherein the inner axle is a hydraulic axle therein the inner axle further comprises a plurality of sleeves and a hydraulic coupling;
the plurality of sleeves are co-located with the plurality of holes in the inner axle, fit through the holes and are sealed to the inner axle with a weld; and
the hydraulic coupling is located at the end opposite the spindle to connect the inner axle to the hydraulic system.

6. The quick replace axle of claim 5 wherein the inner axle further comprises a disk break assembly;
the disk break assembly comprises a rotor and break pad assembly;
the rotor is attached to the hub a rotor and the break pad assembly is bolted to a support plate;
the support plate being attached to the inner axle by an attachment means; and
the disk break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

7. The quick replace axle of claim 5 wherein the inner axle further comprises a drum break assembly;
the drum break assembly comprises a break drum, backing plate, break cylinder a leading line shoe assembly, and a trailing line shoe assembly;
the backing plate is attached to the spindle and comprises the break cylinder, leading line shoe assembly, and trailing line shoe assembly;
the break drum is attached to the stud of the wheel assembly; and
the drum break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

8. The quick replace axle of claim 1 wherein outer sleeve is made up of a pair of sleeves, one sleeve for one side of the vehicle with a second sleeve on the opposing side of the vehicle for the opposite wheel.

9. The quick replace axle of claim 8 wherein the inner axle further comprises a disk break assembly;
the disk break assembly comprises a rotor and break pad assembly;
the rotor is attached to the hub a rotor and the break pad assembly is bolted to a support plate;
the support plate being attached to the inner axle by an attachment means; and
the disk break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

10. The quick replace axle of claim 8 wherein the inner axle further comprises a drum break assembly;
the drum break assembly comprises a break drum, backing plate, break cylinder a leading line shoe assembly, and a trailing line shoe assembly;
the backing plate is attached to the spindle and comprises the break cylinder, leading line shoe assembly, and trailing line shoe assembly;
the break drum is attached to the stud of the wheel assembly; and
the drum break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

11. The quick replace axle of claim 8 wherein the inner axle is a hydraulic axle therein the inner axle further comprises a plurality of sleeves and a hydraulic coupling;
the plurality of sleeves are co-located with the plurality of holes in the inner axle, fit through the holes and are sealed to the inner axle with a weld; and
the hydraulic coupling is located at the end opposite the spindle to connect the inner axle to the hydraulic system.

12. The quick replace axle of claim 11 wherein the inner axle further comprises a disk break assembly;
the disk break assembly comprises a rotor and break pad assembly;
the rotor is attached to the hub a rotor and the break pad assembly is bolted to a support plate;
the support plate being attached to the inner axle by an attachment means; and
the disk break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

13. The quick replace axle of claim 11 wherein the inner axle further comprises a drum break assembly;
the drum break assembly comprises a break drum, backing plate, break cylinder a leading line shoe assembly, and a trailing line shoe assembly;
the backing plate is attached to the spindle and comprises the break cylinder, leading line shoe assembly, and trailing line shoe assembly;
the break drum is attached to the stud of the wheel assembly; and
the drum break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

14. The quick replace axle of claim 1 wherein outer sleeve is made up of a plurality of sleeves aligned such that the inner axle on each side of the vehicle can be inserted through the plurality of sleeves in order for the axle to be attached to the vehicle.

15. The quick replace axle of claim 14 wherein the inner axle further comprises a disk break assembly;
the disk break assembly comprises a rotor and break pad assembly;
the rotor is attached to the hub a rotor and the break pad assembly is bolted to a support plate;
the support plate being attached to the inner axle by an attachment means; and
the disk break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.

16. The quick replace axle of claim 14 wherein the inner axle further comprises a drum break assembly;
the drum break assembly comprises a break drum, backing plate, break cylinder a leading line shoe assembly, and a trailing line shoe assembly;
the backing plate is attached to the spindle and comprises the break cylinder, leading line shoe assembly, and trailing line shoe assembly;
the break drum is attached to the stud of the wheel assembly; and
the drum break assembly further comprises a hydraulic coupling such that the break pad assembly can be charged with hydraulic fluid without risk of leakage and a brake-line of the vehicle can be removed from the disk break of the quick release axle that is being removed and connected to a new quick replace axle without the need of bleeding the brake-line.
